(19) United States
(12) Patent Application Publication
(10) Pub. No.: US 2024/0037678 A1
(43) Pub. Date: Feb. 1, 2024

(54) SYSTEM AND METHOD FOR DYNAMIC MENU AND DISH PRESENTATION

(71) Applicant: TECHNOLOGIES UEAT INC., Québec (CA)

(72) Inventors: Bernard IMBERT, Québec (CA); Benoit CARRIER, Québec (CA); Julien ALLARD, Québec (CA); Alexandre MARTIN, Québec (CA)

(73) Assignee: TECHNOLOGIES UEAT INC., Québec (CA)

(21) Appl. No.: 18/268,888

(22) PCT Filed: Dec. 22, 2021
(86) PCT No.: PCT/CA2021/051874

§ 371 Date: Jun. 21, 2023

Related U.S. Application Data
(60) Provisional application No. 63/129,109, filed on Dec. 22, 2020.

(51) Int. Cl. G06Q 50/12; G06F 3/0482

(52) U.S. Cl. CPC G06Q 50/12; G06F 3/0482

(57) ABSTRACT

A system for menu and dish presentation in a dish ordering environment comprises a front end module including a user interface to be presented on a user computing device and a back end module in data communication with a plurality of data sources and receiving therefrom menu data inputs. The back end module comprises a dynamic menu presentation module to dynamically generate a menu presentation, a dynamic dish configuration scheme module configured to receive user input data regarding a selection of a dish or a built of a dish by the user, from a menu presented in accordance with the menu presentation and to dynamically generate a dish configuration presentation to be presented on the user interface of the front end module.

### CROSS-REFERENCE TO RELATED APPLICATIONS

This application claims priority under 35 USC § 119(e) of US provisional patent application(s) 63/129,109, the specification of which being hereby incorporated by reference.

### TECHNICAL FIELD OF THE INVENTION

The present invention relates to the field of automated user recommendations in a computerized item ordering environment. More particularly, it relates to a system and a method for providing automated personalized and dynamic recommendations for menus and dish items in a menu selection for a user.

### BACKGROUND

Online shopping and self-ordering are types of shopping which are now commonly used for purchasing a large diversity of items, including dishes from restaurants. In order to try to maximize sales and/or conversion rates in transactional apps or websites used for online shopping and self-ordering terminals (or other self-ordering devices such as drive in ordering displays), it has become common practice for online retailers to provide product recommendations, where specific systems are used to determine the most likely relevant products for a user accessing the transactional app or website and to display the recommended product on the interface in order to provide purchase guidance or alternatives to the user and therefore improve its shopping experience.

Currently, the most common methods and systems for performing product recommendations are based on product popularity data and/or historical product purchase/view data of a user or a group of users. In other words, the recommended products are normally the most purchased products or the products related to previously bought or viewed items of a particular user or group of users. In some cases, product recommendation can also be dynamic, i.e. consider live parameters in the determination of the product recommendations (e.g. trending products or the like).

In view of the above, in the field of online dish orders, it is therefore known to suggest or promote the most popular food articles, dishes or combos in a menu displayed to a user (or a group of users) in an online restaurant purchase app or website (or any self-ordering device or system), where either item popularity data, item trending data and/or historical purchase/view data of a specific user or group of users are used as criteria to perform the recommendation.

For example, Chinese patent no. CN104133901 discloses a recommendation system for meal ordering, where a recommendation module comprises a data-mining module and a scenario analysis module, which are configured to establish correlations between various attributes (for example client attributes (e.g. sex, age, occupation, etc.), situation attributes (time, table type, location, lighting, number of people in group, etc.), etc.) and corresponding historically ordered meals and to use the correlations to perform an analysis for a specific instance and provide a product recommendation corresponding to the most likely product.

Chinese patent no. CN105844553 discloses a method and system for a food order server to generate dynamic recommended menus according to the characteristic information data acquired from users of a same group of people ordering using multiple food ordering terminals and to display the dynamic recommended menus to the users of the group on the multiple food ordering terminals.

Known dish recommendation system and methods however tend to suffer from several drawbacks. Indeed, known systems and methods for dish or food items recommendations are limited to providing one or a plurality of product recommendations based on different criteria and do not provide dynamic customized menu presentation where a plurality of aspects of the menu are automatically customized. Moreover, known system and methods for dish or food items recommendation do not dynamically update menu presentation or item selection options based on current user selections, which can also negatively impact sales and/or conversion rates.

In view of the above, there is a need for an improved method and/or system for dynamic menu and/or dish presentation in a dish ordering environment which, by virtue of its design and components, would be able to overcome or at least minimize some of the above-discussed prior art concerns.

As can be appreciated, this presents significant technical challenges in order to provide the most relevant information to the user in the most relevant presentation possible.

### SUMMARY OF THE INVENTION

In accordance with a first general aspect, there is provided a computer implemented method for automatic and dynamic menu and dish presentation. The method comprises the steps of: receiving menu data inputs from a plurality of data sources; dynamically generating a menu presentation to be presented on a user interface using the received menu data inputs, the menu presentation including at least one of a list of categories, a defined rank/sequence for the presentation of the categories, a list of dish for each category and a custom presentation of each dish; transmitting the menu presentation to the user interface and displaying the menu presentation on the user interface, the user interface being accessible by a user on a user computing device; receiving user inputs from the computing device, the user inputs being relative to user selections of menu items displayed on the user interface according to the menu presentation; dynamically generating a dish configuration presentation to be presented on the user interface, the dish configuration presentation being generated based on the user inputs and including a list of dish configuration choices for building a selected dish and a defined rank/sequence for the presentation of the configuration choices, with dish configuration items provided for each one of the dish configuration choices having a custom presentation; and transmitting the dish configuration presentation to the user interface and displaying the dish configuration presentation on the user interface.

In an embodiment, the custom presentation of each dish includes at least one of a selection of an image associated with the dish, a selection of a description of the dish and a rank/sequence for the presentation of the dish in the associated category.

In an embodiment, the dish configuration items of the list of dish configuration choices for building a selected dish includes possible side dishes.

In an embodiment, the custom presentation of side dishes includes a selection of an image associated to the corresponding one of the side dishes, a selection of a description of the corresponding one of the side dishes and a rank/sequence for the presentation of the corresponding one of the side dishes.

In an embodiment, the dish configuration items of the list of dish configuration choices for building a selected dish further includes at least one of possible beverages, possible complementary dishes and possible options/extras.

In an embodiment, the custom presentation of at least one of the possible beverages, possible complementary dishes and possible options/extras includes a selection of an image associated to the corresponding one of the possible beverages, possible complementary dishes and possible options/extras, a selection of a description of the corresponding one of the possible beverages, possible complementary dishes and possible options/extras and a rank/sequence for the presentation of the corresponding one of the possible beverages, possible complementary dishes and possible options/extras.

In an embodiment, the computer implemented method further comprises generating specific menu or dish configuration item recommendations for an item of at least one of the menu presentation and the dish configuration presentation using a recommender system including at least one machine learning recommendation model trained using a labelled dataset.

In an embodiment, the labelled dataset comprises data labelled using at least one of dish/food attribute data, historical user data, historical purchase data and contextual data regarding purchases.

In an embodiment, the step of generating specific menu or dish configuration item recommendations for an aspect of at least one of the menu presentation and the dish configuration presentation using a recommender system comprises selecting at least one recommended system from a plurality of available recommender systems.

In an embodiment, the computer implemented method further comprises receiving feedback data, processing the feedback data to generate an updated dataset and using the updated dataset to train a corresponding one of the at least one machine learning recommendation model.

In an embodiment, at least one of the steps of dynamically generating a menu presentation and dynamically generating a dish configuration presentation comprises generating a recommendation vector including a plurality of menu or dish configuration item recommendations.

In an embodiment, at least one of the steps of dynamically generating a menu presentation and dynamically generating a dish configuration presentation comprises filtering the entries of the recommendation vector based on business rules associated to a corresponding restaurant.

In accordance with another general aspect, there is also provided a system for automatic and dynamic menu and dish presentation in a dish ordering environment. The system comprises: a front end module including a user interface to be presented on a display media of a user computing device and a back end module in data communication with a plurality of data sources and receiving therefrom menu data inputs. The back end module comprises: a dynamic menu presentation module configured to dynamically generate a menu presentation to be presented on the user interface of the front end module, the menu presentation including at least one of a list of categories, a defined rank/sequence for the presentation of the categories, a list of dish for each category and a custom presentation of each dish; and a dynamic dish configuration scheme module configured to receive user input data generated based on user inputs received from the computing device regarding user selections of menu items from a menu presented on the user interface in accordance with the menu presentation, the dynamic dish configuration scheme module being further configured to dynamically generate a dish configuration presentation to be presented on the user interface of the front end module, based on the user inputs and including at least one of a list of dish configuration choices for building a selected dish and a defined rank/sequence for the presentation of the configuration choices, with dish configuration items provided for each one of the dish configuration choices having a custom presentation.

In an embodiment, the custom presentation of each dish includes at least one of a selection of an image associated with the dish, a selection of a description of the dish and a rank/sequence for the presentation of the dish in the associated category.

In an embodiment, the dish configuration items of the list of dish configuration choices for building a selected dish includes possible side dishes.

In an embodiment, the custom presentation of side dishes includes a selection of an image associated to the corresponding one of the side dishes, a selection of a description of the corresponding one of the side dishes and a rank/sequence for the presentation of the corresponding one of the side dishes.

In an embodiment, the dish configuration items of the list of dish configuration choices for building a selected dish further includes at least one of possible beverages, possible complementary dishes and possible options/extras.

In an embodiment, the custom presentation of at least one of the possible beverages, possible complementary dishes and possible options/extras includes a selection of an image associated to the corresponding one of the possible beverages, possible complementary dishes and possible options/extras, a selection of a description of the corresponding one of the possible beverages, possible complementary dishes and possible options/extras and a rank/sequence for the presentation of the corresponding one of the possible beverages, possible complementary dishes and possible options/extras.

In an embodiment, the system further comprises a machine learning recommendation module in data communication with the back end module. The machine learning recommendation module is configured to generate a vector including a plurality of menu or dish configuration item recommendations used by at least one of the dynamic menu presentation module and the dynamic dish configuration scheme module to respectively generate the menu presentation and the dish configuration presentation.

In an embodiment, the machine learning recommendation module includes a plurality of recommender systems, each configured to provide specific menu or dish configuration item recommendations for a corresponding one of an item of the menu presentation or an item of the dish configuration presentation.

In an embodiment, each one of the recommender systems includes a recommender algorithm and at least one machine learning recommendation model trained using a labelled dataset.

In an embodiment, the labelled dataset comprises data labelled using at least one of dish/food attribute data, historical user data, historical purchase data and contextual data regarding purchases.

In an embodiment, the system further comprises a business rule module filtering the entries of the recommendation vector based on business rules associated to a corresponding restaurant.

In an embodiment, the machine learning recommendation module is in data communication with an AI data service connected to an AI database and a feature store connected to an online serving datastore. The system further comprises a feedback module receiving raw feedback data from the back end module and storing the raw feedback data in a feedback datastore.

In an embodiment, the feedback module comprises a batch processor repeatedly processing raw feedback data from the feedback datastore in batch and storing the processed data in an intermediate database.

In an embodiment, wherein the feedback module further comprises a service processing module processing the semi-processed processed data from the intermediate database and updating the AI database and the AI data service to reflect changes to the intermediate database.

In an embodiment, the feedback module further comprises a dataset creation module configured to process the semi-processed data from the intermediate database and to generate a training dataset adapted to a corresponding machine learning recommendation model.

In an embodiment, the feedback module further comprises a feature update module configured to generate features for the corresponding machine learning recommendation model and to update the feature store and online serving datastore accordingly.

In an embodiment, the feedback module further comprises a model training module configured to perform training of the corresponding machine learning recommendation model using the generated dataset.

In an embodiment, the plurality of data sources includes the user computing device, at least one third party data source and at least one internal data source.

### BRIEF DESCRIPTION OF THE DRAWINGS

Other objects, advantages and features will become more apparent upon reading the following non-restrictive description of embodiments thereof, given for the purpose of exemplification only, with reference to the accompanying drawings in which:

FIG. 1 is a schematic representation illustrating a system for dynamic menu and/or dish presentation in a dish ordering environment, according to an embodiment.

FIG. 2 is a schematic representation illustrating the system for dynamic menu and/or dish presentation in a dish ordering environment of FIG. 1, with extended components thereof, according to an embodiment.

FIG. 3 is a schematic representation illustrating the machine learning recommendation module, AI data service and feature store of the system for dynamic menu and/or dish presentation of FIG. 2, in accordance with an embodiment.

FIG. 4 is a schematic illustrating the components of the feedback module of the system for dynamic menu and/or dish presentation of FIG. 2, in accordance with an embodiment.

FIG. 5 is an image presenting a view of the user interface of the system for dynamic menu and/or dish presentation of FIG. 1, showing a menu presentation displayed on the user interface.

FIG. 6 is an image presenting a view of the user interface of the system for dynamic menu and/or dish presentation of FIG. 1, showing a selected dish presentation displayed on the user interface.

FIG. 7 is a flowchart showing the steps of the computer implemented method for dynamic menu and/or dish presentation, in accordance with an embodiment.

### DETAILED DESCRIPTION

In the course of the present description, the same numerical references refer to similar elements. The embodiments, configurations and/or alternatives shown in the figures or described in the present description are embodiments only, given solely for exemplification purposes.

In the following description, the embodiments of the system for dynamic menu and/or dish presentation in a dish ordering environment consist of certain components. As explained and illustrated herein, not all of these components are essential and thus should not be taken in their restrictive sense. It is to be understood, as also apparent to a person skilled in the art, that other suitable components and cooperation thereinbetween, as well as other suitable geometrical configurations, can be used for the system for dynamic menu and/or dish presentation, as will be briefly explained herein and as can be easily inferred herefrom by a person skilled in the art.

Moreover, although the associated method includes steps as explained and illustrated herein, not all of these steps are essential and thus should not be taken in their restrictive sense. It will be appreciated that the steps of the method for dynamic menu and/or dish presentation described herein can be performed in the described order, or in any suitable order.

To provide a more concise description, some of the quantitative and qualitative expressions given herein can be qualified with the terms “about” and “substantially”. It is understood that whether the terms “about” and “substantially” are used explicitly or not, every quantity or qualification given herein is meant to refer to an actual given value or qualification, and it is also meant to refer to the approximation to such given value or qualification that would reasonably be inferred based on the ordinary skill in the art, including approximations due to the experimental and/or measurement conditions for such given value.

The term “computing device” encompasses computers, servers and/or specialized electronic devices which receive, process and/or transmit data. “Computing devices” are generally part of “systems” and include processing means, such as microcontrollers and/or microprocessors, CPUs or are implemented on FPGAs, as examples only. The processing means are used in combination with storage media, also referred to as “memory” or “storage means”. Storage media can store instructions, algorithms, rules and/or trading data to be processed. Storage media encompasses volatile or non-volatile/persistent memory, such as registers, cache, RAM, flash memory, ROM, as examples only. The type of memory is chosen according to the desired use, whether it should retain instructions, or temporarily store, retain or update data. Steps of the proposed method are implemented as software instructions and algorithms, stored in computer memory and executed by processors. It should be understood that servers and computers are required to implement to proposed system, and to execute the proposed method.

In accordance with the embodiments described herein, there is provided a system for dynamic menu and/or dish presentation in a dish ordering environment, which, as will be described in more details below, is designed for initially dynamically creating and presenting a custom menu to a user and subsequently dynamically creating and presenting a dish configuration scheme based at least in part on user selections or data input from the custom menu and the presented dish configuration scheme. As will be described in more details below, the system is designed to operate in a network-accessible environment, using machine learning.

One skilled in the art will understand that each module described in the present application can be implemented via programmable computer components, such as one or more physical or virtual computers comprising a processor and memory having instructions stored thereon. It is appreciated, however, that other configurations are possible. Moreover, the modules and data sources described herein can be in data communication through direct communication such as a wired connection or via a communication network allowing data communication between computing devices or components of a network capable of receiving or sending data.

One skilled in the art will understand that, in the course of the present description, the term “communication network” is used to refer to any network allowing data communication between computing devices or components of a network capable of receiving or sending data, which includes publicly accessible networks of linked networks, possibly operated by various distinct parties, such as the Internet, private networks (PN), personal area networks (PAN), local area networks (LAN), wide area networks (WAN), cable networks, satellite networks, cellular telephone networks, etc. or combination thereof.

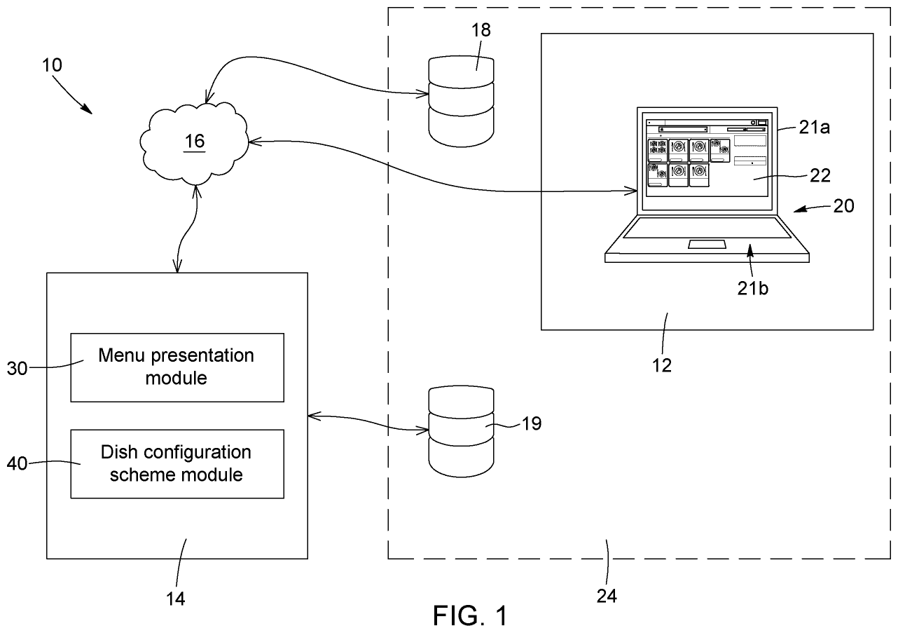

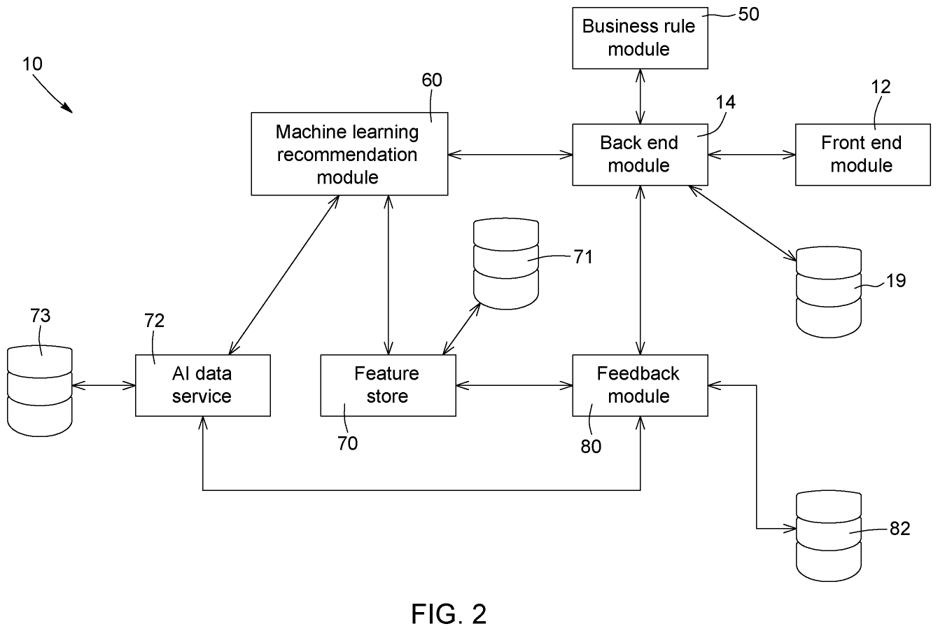

Referring generally to FIGS. 1 and 2, in accordance with one embodiment, there is shown the system 10 for dynamic menu and/or dish presentation in a dish ordering environment. The system 10 comprises a front end module 12 and a back end module 14.

As can be seen in the Figures, the front end module includes a user interface 22. In the embodiment shown, the user interface 22 is a visual display user interface configured to be displayed on a user computing device 20. It will be understood that the user computing device 20 can include a wide variety of computing devices, including personal devices, laptop computers, tablets, electronic reader, mobile devices (e.g., mobile phones, media players, handheld gaming devices, etc.), wearable devices with network access and program execution capabilities (e.g., “smart watches” or “smart eyewear”), wireless devices, set-top boxes, gaming consoles, entertainment systems, televisions with network access and program execution capabilities (e.g., “smart TVs”), terminal devices allowing on-premise self-ordering, and various other electronic devices and appliances.

In the embodiment shown, the user computing device 20 includes a display media 21a such as a display screen or the like and user input means 21b allowing the user to input data relative to menu/food items selections from the user computing device 20. User input means 21b for inputting data are well known in the art and include devices such as, for example and without being limitative, keyboard, mouse, touchscreen, etc.

In an alternative embodiment (not shown), the user interface 22 could be of a different type than a visual display interface, such as, for example and without being limitative, a vocal command interface allowing vocal interactions between the user and the user computing device 20. In such an embodiment, the user interface 22 can be configured to output audio data to the user via a speaker of the user computing device 20. For example and without being limitative, the outputted audio data can be provided using speech synthesis tools allowing production of human like speech for a menu presentation and/or dish presentation (e.g. dish/food items for a specific menu, side dishes, complementary dishes, drinks, extras, etc.) based on text data of the menu presentation and/or dish presentation. Moreover, in such an embodiment, the user input means 21c can include audio microphones (or sound transducers) and corresponding voice control components performing voice recognition, such that a user can interact with the user interface 22 using common speech or voice commands to input data relative to menu/food items selections.

Using the user interface 22 of the front end module 12, users can therefore interact with the system 10 and be presented with the menu offered by a selected restaurant (which includes dish/food items presented according to a specific dynamic menu presentation, as will be described in more details below) and to perform user selections. In an embodiment, the user selections can include the selection of the dish/food items presented in the menu displayed on the user interface 22, using the input means 21c of the user computing device 20, as well as associated side dishes, complementary dishes, drinks, extras, etc., displayed on the user interface 22. In an embodiment, the system 10 is configured to communicate the user selections and actions from the front end module 12 to a back end module 14 being in data communication with the front end module 12 via a communication network 16.

The back end module 14 is configured to receive and process menu data inputs and to generate therefrom dynamic menu/food items recommendations to be presented on the user interface 22 of the front end module 12. More particularly, the back end module 14 is operative to receive the menu data inputs from a plurality of data sources 24 and to dynamically generate the custom menu configuration scheme and the dish configuration scheme to be presented on the user interface 22 of the front end module 12. As mentioned above, in an embodiment, the back end module 14 is also configured to receive user inputs regarding menu/food items selections performed by the user using the user interface 22 of the front end module 12, such that the back end module 14 can dynamically generate an updated custom menu and/or an updated dish configuration scheme to be presented on the user interface 22 of the front end module 12, according to the menu/food items selections inputted by the user and acquired by the front end module 12.

In an embodiment, the menu data inputs received by the back end module 14 include user information data, dish/food item data and contextual data. One skilled in the art will also understand that, in alternative embodiments, the menu data inputs could also include other types of data which can help in providing the dynamic menu/food items recommendation. For example and without being limitative, in an embodiment, the user information data can include at least one of user profile and historical purchase data, system preference and historical use data, geolocation data, demographic data (age, sex, ethnicity, salary range, work status, etc.), IP address, type of car (acquired via images captured of user car for drive-in orders), physical user attributes (which can for example be acquired from images captured from camera of the user computing device 20), etc. For example and without being limitative, in an embodiment, the dish/food item data includes at least one of ID of the restaurant, primary restaurant domain, secondary restaurant domain, flavors and/or ontology of the dish/food items of the restaurant, preparation time of dish/food items, cost of the dish/food items, profitability of the dish/food items etc. For example and without being limitative, in an embodiment, the contextual data can include at least one of the current data and time, current season, current weather, current global or local events, current occupation rate of restaurant etc.

One skilled in the art will understand that the plurality of data sources 24 from which the menu data inputs are acquired by the back end module 14 can be varied and can include any data source in data communication with the back end module 14 and/or the front end module 12 (directly or indirectly) and storing therein at least one data attribute that is part of the menu data inputs. In the embodiment shown, the plurality of data sources 24 includes the user computing device 20, a third party data source 18 and an internal data source 19. One skilled in the art will understand that, in alternative embodiments, other data sources and/or more than one third party data source 18 and internal data source 19 can be provided. The user computing device 20 can provide input data stored in a memory thereof or data acquired/generated using the user computing device 20 or components thereof (e.g. images captured by a camera thereof, user inputs from user input means, geolocation data from GPS chip, etc.). The third party data source(s) 18 can include online servers and/or databases connected to the back end module 14 via the communication network 16 and which are managed by a third party entity—such as, for example and without being limitative, a weather condition database, an event notification database, or the like. The internal data source 19 can include servers and/or databases of the system 10 in data communication with the back end module 14—such as, for example and without being limitative a central database or a plurality of distributed databases storing user information data and/or dish/food item data which can be retrieved using, for example, corresponding user identifiers and/or dish/food item identifiers corresponding to a specific user, a specific user attribute, a specific dish/food item, a dish/food item attribute, etc.

One skilled in the art will understand that, in an embodiment, the back end module 14 can include one or more data processing modules (not shown) cooperating to process the data received from at least one of the user computing device 20, the third party data source 18 and the internal data source 19 (or any other data source) storing or generating the menu data inputs. For example and without being limitative, in an embodiment, the back end module can include an image processing module configured to receive data relative to images acquired by a camera (or other image capture component) of the user computing device 20, process the received data and generate contextual data and/or user related data, based on information extracted from the acquired image, or the like.

As can be seen in the Figures, in the embodiment shown, the back end module 14 includes a dynamic menu presentation module 30 and a dynamic dish configuration scheme module 40.

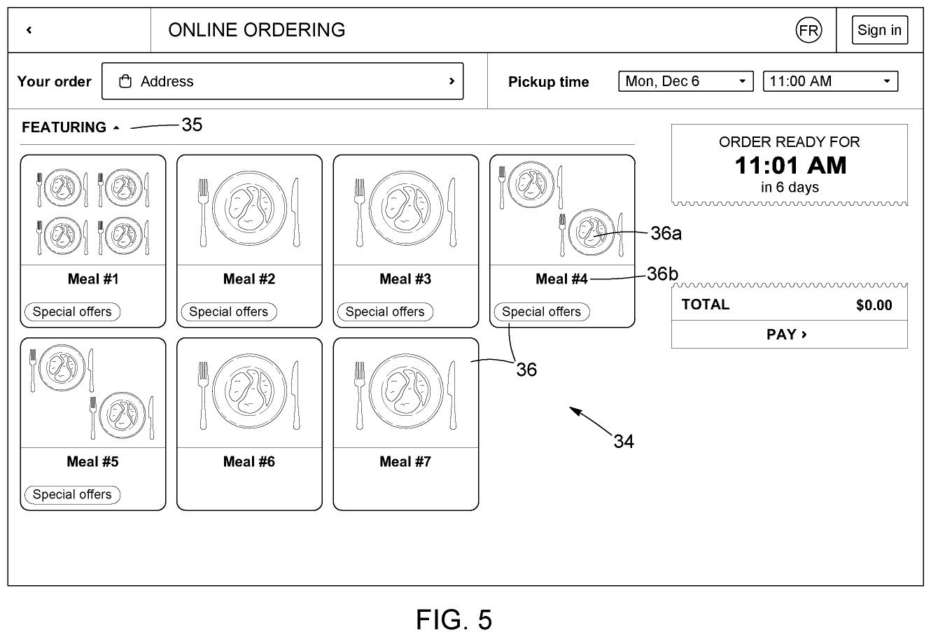

The dynamic menu presentation module 30 is configured to dynamically generate a menu presentation to be presented on the user interface 22 of the front end module 12, in order to render the menu of a corresponding restaurant on the user interface 22 presented by the user computing device 20. A schematic exemplary menu presentation, in accordance with an embodiment, is shown in FIG. 5.

In an embodiment, the menu presentation includes: a list of categories 35 and a defined rank/sequence for the presentation of the categories (i.e. the rank in which the selected categories are to be presented on the GUI); and, for each category, a list of dish 36 and a custom presentation of the dish. In an embodiment, the custom presentation of the dish includes a selection of an image 36a associated with the dish, a selection of a description 36b of the dish and a rank/sequence for the presentation of the dish in the associated category (i.e. the rank in which the dishes are to be presented for the associated category on the GUI). In an alternative embodiment, the custom presentation of the dish can be free of the selection of the image associated with the dish, i.e. no image can be associated with the dish or a generic image can be presented for the dish without being dynamically selected.

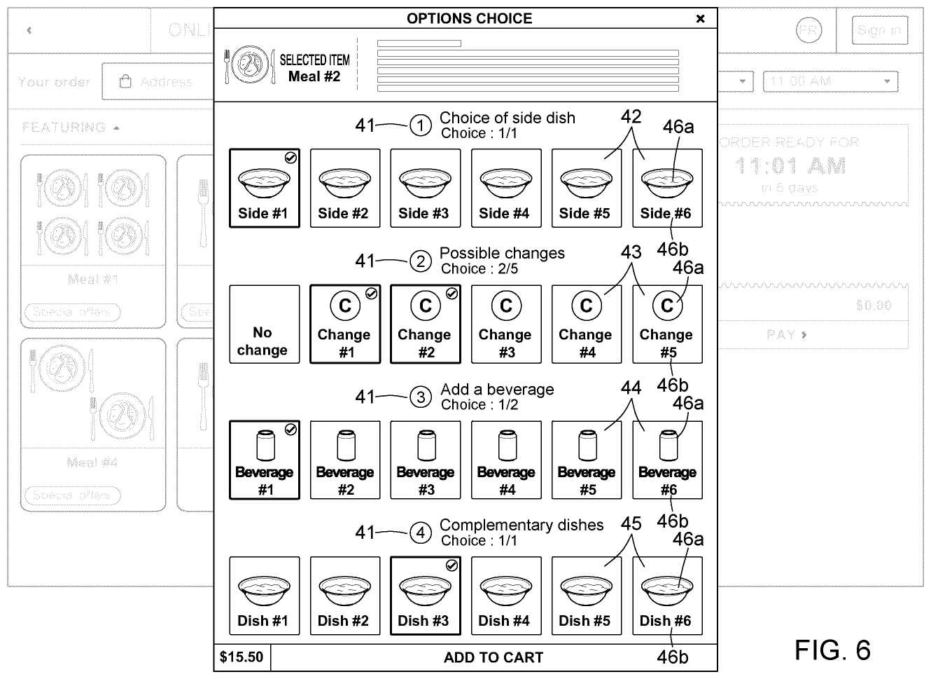

The dynamic dish configuration scheme module 40 is configured to dynamically generate a dish configuration presentation to be presented on the user interface 22 of the front end module 12, following a selection of a dish by the user, from the menu presented on the user interface 22 of the user computing device 20 (in accordance with the menu presentation generated by the menu presentation module 30). A schematic exemplary dish configuration presentation, in accordance with an embodiment, is shown in FIG. 6.

In an embodiment, the dish configuration presentation includes a list of dish configuration choices 41 for building the selected dish 36 and a defined rank/sequence for the presentation of the configuration choices (i.e. the rank in which the configuration choices are to be presented for the dish on the GUI), with the items provided for each one of the dish configuration choices 41 having a custom presentation.

In an embodiment, the dish configuration items provided for each one of the dish configuration choices includes possible side dishes 42 and can also include at least one of possible beverages 44, possible complementary dishes 45 and/or possible options/extras 43. Therefore, in other words, in an embodiment, the list of dish configuration choices 41 includes a list of side dishes 42 and a custom presentation of each one of the side dishes 42 of the list and can also include at least one of a list of options/extras 43 for at least one of the dishes 36 and the side dishes 42 and a custom presentation of each one of the options/extras 43 of the list, and a list of possible added beverages 44 and a custom presentation of each one of the possible beverages 44 of the list and a list of complementary dishes 45 and a custom presentation of each one of the complementary dishes 45. One skilled in the art will understand that, in other embodiments (not shown), the list of dish configuration choices 41 can include additional configuration options or different configuration options than the embodiment shown.

Once again, in an embodiment, the custom presentation of each one of the possible side dishes 42, possible beverages 44, possible complementary dishes 45 and/or possible options/extras 43 can include: a selection of an image 46a associated to the corresponding one of the possible side dishes 42, possible beverages 44, possible complementary dishes 45 and/or possible options/extras 43; a selection of a description 46b of the corresponding one of the possible side dishes 42, possible beverages 44, possible complementary dishes 45 and/or possible options/extras 43; and a rank/sequence for the presentation of the corresponding one of the possible side dishes 42, possible beverages 44, possible complementary dishes 45 and/or possible options/extras 43 in the respective list thereof In an alternative embodiment, the custom presentation of the possible side dishes 42, possible beverages 44, possible complementary dishes 45 and/or possible options/extras 43 can be free of at least one of the selection of the image, the selection of the description and the rank/sequence for the presentation of the corresponding one of the possible side dishes 42, possible beverages 44, possible complementary dishes 45 and/or possible options/extras 43 in the respective list thereof. In other words, in an embodiment, no image or no description can be associated with the corresponding one of the possible side dishes 42, possible beverages 44, possible complementary dishes 45 and/or possible options/extras 43, or a generic image and/or description can be presented without being dynamically selected.

As can be seen more clearly in FIG. 2, in the embodiment of the system 10 shown, the system 10 further includes a business rule module 50 and a machine learning recommendation module 60 in data communication with the back end module 14 (and the dynamic menu presentation module 30 and the dynamic dish configuration scheme module 40 thereof). The machine learning recommendation module 60 is configured to provide dish recommendations which are used by the dynamic menu presentation module 30 and the dynamic dish configuration scheme module 40 to respectively generate the menu presentation and the dish configuration presentation. The business rule module 50, is configured to provide business rules in order to filter the recommendations from the machine learning recommendation module 60, in accordance with the business rules of the specific restaurant such as, for example and without being limitative, the current availability of dishes, the cost of the dishes, the profitability of the dishes, the preparation time of the dishes or the like or other restaurant specific considerations resulting in a restaurant wishing to modify the menu presentation and/or the dish configuration presentation (e.g. increase or decrease the rank/sequence associated with specific ones of the possible side dishes 42, possible beverages 44, possible complementary dishes 45 and/or possible options/extras 43 in the corresponding list).

In view of the above, one skilled in the art will understand that the business rules can define dishes, side dishes, complimentary dishes, beverages and/or options/extras to be removed from the menu or to be obligatorily displayed in the menu presentation or dish presentation. The business rules can also define a preset rank/sequence for the presentation of the corresponding one of the possible dishes, side dishes, complimentary dishes, beverages and/or options/extras.

In an embodiment, the system allows the business rules applicate by the business rule module 50 to be modified by a user having the necessary credentials for logging into the system. Therefore, for example and without being limitative, a user wishing to promote an item can modify the business rules of the business rule module 50, to ensure that the dishes, side dishes, complimentary dishes, beverages and/or options/extras is either hidden or displayed on the menu or dish presentation, or is displayed at the desired rank/sequence.

In an embodiment, the system 10 also includes a feature store 70 and an AI data service 72 in data communication with the machine learning recommendation module 60.

The feature store 70 is in data communication with an online serving datastore 71 and includes the features of the system 10, which are used for the training and the operation of the machine learning recommendation models used by the machine learning recommendation module 60. The AI data service 72 is responsible for storing and querying the data used by the machine learning recommendation module 60 and includes an AI database 73 storing the data regarding users, historical prediction, historical purchases, historical user selections, dish/food items attributes, etc., which are used by the machine learning recommendation models 64 used by the machine learning recommendation module 60.

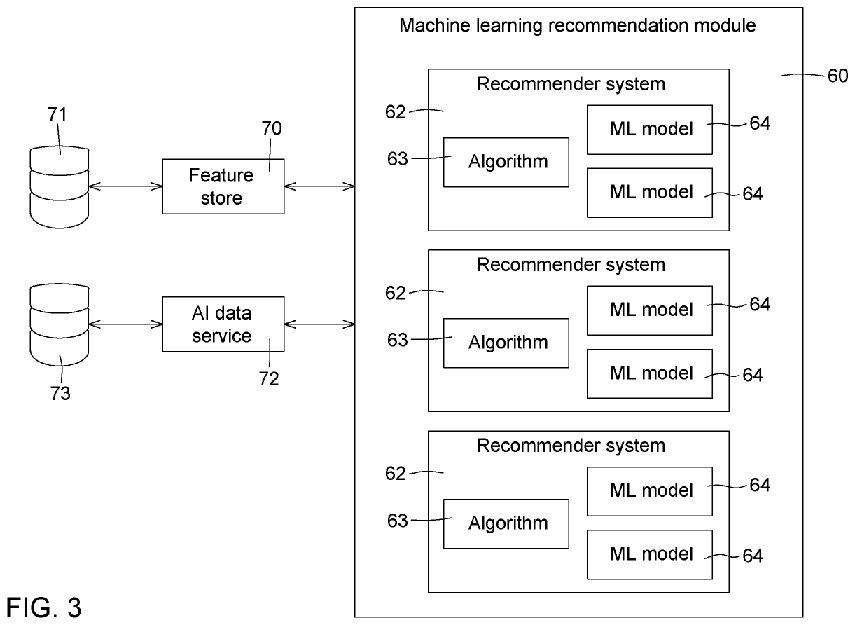

Referring to FIGS. 2 and 3, in more details, in an embodiment the machine learning recommendation module 60 includes a plurality of recommender systems 62, each configured to provide specific menu or dish configuration item recommendations for an item of the menu presentation and/or the dish configuration presentation. In other words, the plurality of recommender systems 62 are each specifically configured to provide a recommendation, for example and without being limitative, regarding one of a list of categories, a rank/sequence for the presentation of the categories, a list of dish in a category, a custom presentation of the dish (including the image associated to the dish, the description of the dish and the rank/sequence for the presentation of dish in the associated category), a list of dish configuration choices for building a selected dish, a rank/sequence for the presentation of the configuration choices, a list of side dishes, a custom presentation for a side dish, a list of complementary dishes and a custom presentation for a complementary dish, a list of possible options/extras and a custom presentation for the possible options/extras, etc.

In an embodiment, selection of which recommender system 62 is being used to provide the menu or dish configuration item recommendations for each item of the menu presentation and/or the dish configuration presentation can be performed manually, based on various performance criteria. In an alternative embodiment, different recommender system 62 can be used for different groups of users for specific items of the menu presentation and/or the dish configuration presentation, during an evaluation time period, in order to evaluate the performance of the different recommender systems 62. The recommender system 62 having had the greatest performance during the evaluation period subsequently being used for the associated item of the menu presentation and/or the dish configuration presentation.

Each one of the recommender systems 62 includes a recommender algorithm 63 and at least one machine learning recommendation model 64 trained using a labelled dataset. In an embodiment the labelled dataset comprises data labelled using at least one of dish/food attribute data, historical user data, historical purchase data, contextual data regarding purchase. For example and without being limitative, in an embodiment, the dish/food attributes can include: restaurant attributes including a primary domain (bar, pub, bakery, fine cuisine, burger, snack bar, etc) and a secondary domain (bar, pub, bakery, fine cuisine, burger, snack bar, etc); dish categories including a type of dish (appetizer, main course, combo, side dish, sauce and condiments, beverage, desert, etc.), metatags (vegetarian, vegan, kids, gluten free, spicy, etc.); ingredients of the dishes; dish classifications for generic dishes (salad, burger, soup, pasta, pizza, cake, etc.). In an embodiment, the ingredients of a dish can be automatically generated based on characteristics of a dish such as, for example and without being limitative, the name of the dish, the description of the dish, images of the dish, the category of the dish, etc. The feature store 70 is in data communication with the machine learning recommendation module 60 to provide the features data to the machine learning recommendation models 64.

The recommender algorithm 63 and machine learning recommendation models 64 receive as input the menu data acquired by the back end module 14. The recommender algorithm 63 and machine learning recommendation models 64 are used by the recommender systems 62 to generate the recommendation data allowing the recommender systems 62 to provide the corresponding menu or dish configuration item recommendations thereof. In an embodiment, the machine learning recommendation models 64 are one of a user-based model where recommendations are provided according to user related input data and a contextual model where recommendations are provided according to context (or situational) related input data.

Hence, in operation, the system 10 is configured such that the dynamic menu presentation module 30 and the dynamic dish configuration scheme module 40 each query the machine learning recommendation module 60 in order to obtain corresponding menu or dish configuration item recommendations therefrom. For example and without being limitative, in an embodiment, the dynamic menu presentation module 30 and the dynamic dish configuration scheme module 40 can provide the above-described menu data inputs, an identifier of the user and data indicative of the amount of recommendations requested and the type of recommendation requested to the machine learning recommendation module 60, as data inputs.

The machine learning recommendation module 60 is configured to select the appropriates recommender systems 62, in accordance with the type of recommendation requested and to query the feature store 70 and the AI data service 72 to obtain the necessary parameters and data for the corresponding machine learning recommendation model 64 thereof. The machine learning recommendation module 60 is further configured to receive the recommendation data from the recommender systems 62 and to generate a recommendation vector including a plurality of menu or dish configuration item recommendations in accordance with the type of recommendation requested.

The recommendation vector is provided to the corresponding one of the dynamic menu presentation module 30 and the dynamic dish configuration scheme module 40 of the back end module 14. The corresponding one of the dynamic menu presentation module 30 and the dynamic dish configuration scheme module 40 queries the business rule module 50 which filters the menu or dish configuration item recommendations of the recommendation vector in accordance with the current business rules of the corresponding restaurant. Based on the filtered recommendations, the dynamic menu presentation module 30 and the dynamic dish configuration scheme module 40 can generate the corresponding one of the menu presentation and the dish configuration presentation and transmit it to the front end module 12, to be presented on the user interface 22 of the user computing device 20.

In an embodiment, the system 10 is configured for the dynamic menu presentation module 30 to initially generate a menu presentation and transmit it to the front end module 12 to be presented on the user interface 22 of the user computing device 20, such that when a user accesses a restaurant menu 34 for a restaurant using the user interface 22 displayed using the user computing device 20, the menu 34 is presented in accordance with a custom presentation for the specific user and context. In an embodiment, the custom presentation includes the custom list of categories 35 with the categories 35 being presented in a custom rank/sequence and in each category 35 the list of dishes 36 having a custom presentation, which includes at least one of the custom image 36a associated to the dish, the custom description 36b of the dish and the custom rank/sequence for the presentation of dish. In an embodiment (not shown), the categories 35 can include subcategories presented in the custom rank/sequence within the associated category 35 and in each subcategory the list of dishes 36 having the custom presentation. In an embodiment, the list of categories (and subcategories) can be provided to the dynamic menu presentation module 30 by the machine learning recommendation module 60.

Following the initial presentation of the menu presentation on the user interface 22 of the user computing device 20, the system 10 is configured to receive from the computing device 20, user inputs inputted by the user using the user input means 21b. The user inputs are relative to user selection of items displayed on the user interface 22 according to the menu presentation shown on the user interface 22 of the user computing device 20 (i.e. are relative to dish selections from the menu presentation). The system is further configured to generate a dish configuration presentation and transmit it to the front end module 12 to be presented on the user interface 22 of the user computing device 20. Therefore, the system operates such that, in response to user inputs regarding dish selections from the menu presentation, the options presented to a user regarding the configuration of the selected dish and the selection of configuration choices are presented in accordance with a custom presentation for the specific user, context and user selections.

In an embodiment, the dish configuration presentation includes the list of dish configuration choices 41 for building the selected dish 36 and a defined rank/sequence for the presentation of the configuration choices. As mentioned above, in an embodiment, the list of dish configuration choices 41 includes at least one of a list of side dishes 42 each having a custom presentation; a list of options/extras 43 for at least one of the dishes 36 and the side dishes 42, each having a custom presentation; a list of possible added beverages 44 each having a custom presentation; and a list of complementary dishes 45 each having a custom presentation. As mentioned above, in an embodiment, each one of the custom presentation can include at least one of a custom image associated to the item, a custom description of the item and a custom rank/sequence for the presentation of the item.

Now referring back to FIG. 2, in an embodiment, the system 10 further includes a feedback module 80 receiving feedback data from the back end module 14 and storing the feedback data in a feedback datastore 82. The feedback data is acquired by the backend module 14 from the user inputs transmitted from the computing device 20 regarding dish selections, dish building (including side dishes and complementary dishes) and purchase data and is therefore representative of user preferences and evaluation of the accuracy of the machine learning recommendation models 64. The feedback module 80 is configured to process the feedback data received from the back end module 14 and to perform automatic repetitive update of the AI data service 72 and the feature store 70 using the processed feedback data.

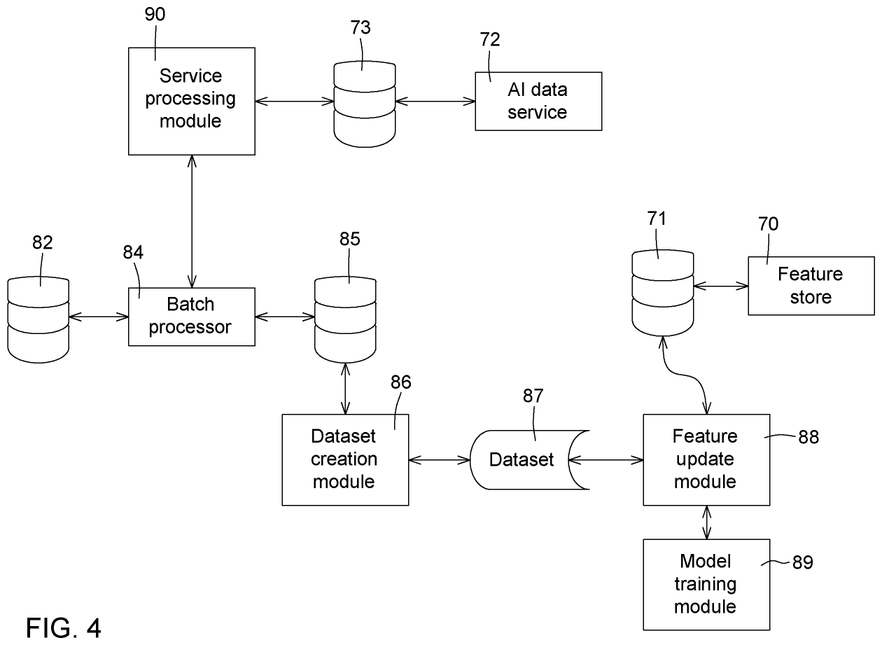

In more details, referring to FIG. 4, in an embodiment, the feedback module 80 of the system 10 includes a batch processor 84 repeatedly processing raw feedback data from the feedback datastore 82 in batch and storing the processed data in an intermediate (semi-processed) database 85 storing semi-processed data regarding users, historical prediction, historical purchases, historical user selections, dish/food items attributes, or the like, to be used for training and/or operation of the machine learning recommendation models 64 used by the recommender systems 62 of the machine learning recommendation module 60. The semi-processed data from the intermediate database 85 can be further processed by a service processing module 90 processing the data and updating the AI database 73 to reflect the new added data of the intermediate database 85 for storage thereof and to perform the update of the corresponding AI data service 72.

The semi-processed data from the intermediate database 85 can also be further processed by a dataset creation module 86 configured to generate a training dataset 87 adapted to a corresponding machine learning recommendation model 64 (i.e. data relevant to features and/or training of the corresponding machine learning recommendation model 64 and reflecting the new added data of the intermediate database 85). The generated dataset 87 can be used by a feature update module 88 configured to generate (or update) features for the corresponding machine learning recommendation model 64 and updating the feature store 70 and online serving datastore 71 accordingly and/or by a model training module 89 configured to perform training of the machine learning recommendation model 64 using the generated dataset 87.

In the course of the description above, the components of the system 10 for dynamic menu and dish presentation have been described. One skilled in the art will understand that, in an embodiment, a corresponding computer implemented method 100 for dynamic menu and dish presentation is also provided.

The computer implemented method 100 allows the dynamic generation and presentation of menu and dish/food item selection, as described above, using the components of the system 10 or different components allowing the occurrence of the actions resulting in the above-described acquisition of the menu data inputs from the plurality of data sources and to generation and presentation of the menu presentation and the dish configuration presentation on the user interface, with the dish configuration presentation being provided in accordance with the menu selections of the user acquired through the user inputs received from the user computing device regarding the menu presentation provided in the graphical user interface.

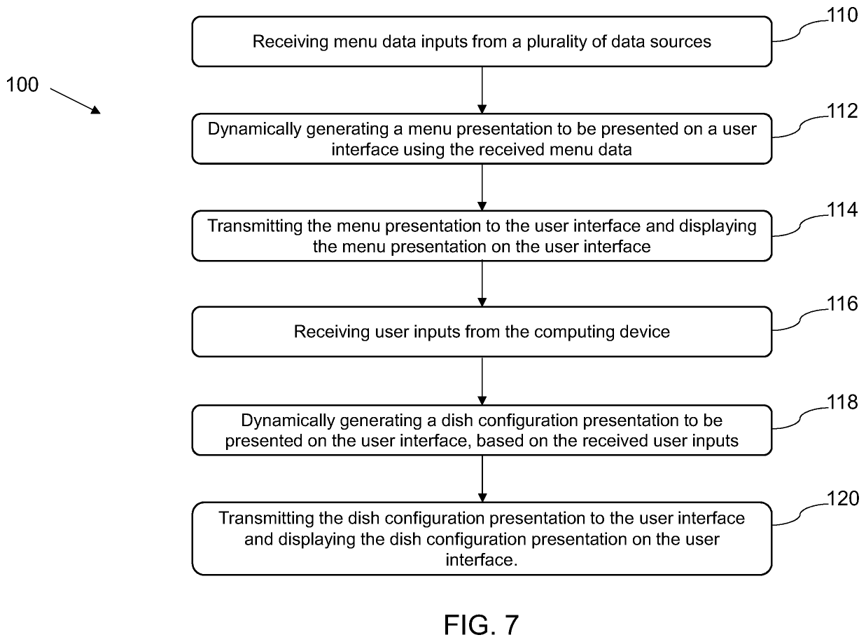

Referring to FIG. 7, in an embodiment, the method 100 includes the step 110 of receiving menu data inputs from a plurality of data sources. As mentioned above, in an embodiment, the menu data inputs can include user information data, dish/food item data and contextual data, or other types of data which can help in providing the dynamic menu/food items recommendation and the plurality of data sources from which the menu data inputs are acquired can include any data source generating or storing at least one data attribute that is part of the menu data inputs.

The method 100 also includes the steps of dynamically generating a menu presentation to be presented on a user interface using the received menu data inputs (step 112) and of transmitting the menu presentation to the user interface and displaying the menu presentation on the user interface (step 114). As previously mentioned, the menu presentation includes at least one of a list of categories, a defined rank/sequence for the presentation of the categories, a list of dish for each category and a custom presentation of each dish. The user interface is an interface displayed on a display media of the user computing device and therefore being accessible by a user on the user computing device

The method 100 includes the further steps of receiving user inputs from the computing device (step 116) and dynamically generating a dish configuration presentation to be presented on the user interface (step 118), based on the received user inputs. As also previously mentioned, the user inputs are relative to user selections of menu items displayed on the user interface according to the menu presentation and the dish configuration presentation include a list of dish configuration choices for building a selected dish and a defined rank/sequence for the presentation of the configuration choices. The dish configuration items provided for each one of the dish configuration choices have a custom presentation.

In an embodiment, the custom presentation of each dish includes at least one of a selection of an image associated with the dish, a selection of a description of the dish and a rank/sequence for the presentation of the dish in the associated category.

In an embodiment, the dish configuration items of the list of dish configuration choices for building a selected dish include possible side dishes and the custom presentation of side dishes includes a selection of an image associated to the corresponding one of the side dishes, a selection of a description of the corresponding one of the side dishes and a rank/sequence for the presentation of the corresponding one of the side dishes.

In an embodiment, the dish configuration items of the list of dish configuration choices for building a selected dish further also include at least one of possible beverages, possible complementary dishes and possible options/extras and the custom presentation of at least one of the possible beverages, possible complementary dishes and possible options/extras includes a selection of an image associated to the corresponding one of the possible beverages, possible complementary dishes and possible options/extras, a selection of a description of the corresponding one of the possible beverages, possible complementary dishes and possible options/extras and a rank/sequence for the presentation of the corresponding one of the possible beverages, possible complementary dishes and possible options/extras.

In the embodiment shown, the method 100 also includes the step 120 of transmitting the dish configuration presentation to the user interface and displaying the dish configuration presentation on the user interface.

In an embodiment, in the computer implemented method, the menu presentation and the dish configuration presentation are generated using a plurality of recommender systems each specifically configured to provide a recommendation regarding at least one of a list of categories, a rank/sequence for the presentation of the categories, a list of dishes in a category, a custom presentation of the dish (including the image associated to the dish, the description of the dish and the rank/sequence for the presentation of the dish in the associated category or subcategory) a list of dish configuration choices for building a selected dish and a rank/sequence for the presentation of the configuration choices, a list of side dishes, a custom presentation for a side dish, a list of complementary dishes, a custom presentation of the complementary dishes, a list of options/extras, a custom presentation of each one of the options/extras, a list of possible added beverages and a custom presentation of each one of the possible beverages 44 of the list. In an embodiment, the plurality of recommender systems each include at least one machine learning recommendation model trained using a labelled dataset and receiving as input data from the menu data inputs. In an embodiment, the labelled dataset comprises data labelled using at least one of dish/food attribute data, historical user data, historical purchase data and contextual data regarding purchases.

The skilled reader will readily recognize that steps of the method can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods. The embodiments are also intended to cover computers programmed to perform said steps of the above-described methods.

It should be appreciated by those skilled in the art that any block diagrams herein represent conceptual views of illustrative circuitry embodying the principles disclosed herein. Similarly, it will be appreciated that any flow charts and transmission diagrams, and the like, represent various processes which may be substantially represented in computer readable medium and so executed by a computer or processor, whether or not such computer or processor is explicitly shown.

Several alternative embodiments and examples have been described and illustrated herein. The embodiments of the invention described above are intended to be exemplary only. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is understood that the invention could be embodied in other specific forms without departing from the central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind. The scope of the invention is therefore intended to be limited solely by the scope of the appended claims.

1. A computer implemented method for automatic and dynamic menu and dish presentation, the method comprising the steps of:
receiving menu data inputs from a plurality of data sources;
dynamically generating a menu presentation to be presented on a user interface using the received menu data inputs, the menu presentation including at least one of a list of categories, a defined rank/sequence for the presentation of the categories, a list of dish for each category and a custom presentation of each dish;
transmitting the menu presentation to the user interface and displaying the menu presentation on the user interface, the user interface being accessible by a user on a user computing device;
receiving user inputs from the computing device, the user inputs being relative to user selections of menu items displayed on the user interface according to the menu presentation;
dynamically generating a dish configuration presentation to be presented on the user interface, the dish configuration presentation being generated based on the user inputs and including a list of dish configuration choices for building a selected dish and a defined rank/sequence for the presentation of the configuration choices, with dish configuration items provided for each one of the dish configuration choices having a custom presentation; and
transmitting the dish configuration presentation to the user interface and displaying the dish configuration presentation on the user interface.

2. The computer implemented method of claim 1, wherein the custom presentation of each dish includes at least one of a selection of an image associated with the dish, a selection of a description of the dish and a rank/sequence for the presentation of the dish in the associated category.

3. The computer implemented method of claim 1, wherein the dish configuration items of the list of dish configuration choices for building a selected dish includes possible side dishes and wherein the custom presentation of side dishes includes a selection of an image associated to the corresponding one of the side dishes, a selection of a description of the corresponding one of the side dishes and a rank/sequence for the presentation of the corresponding one of the side dishes.

4. (canceled)

5. The computer implemented method of claim 3, wherein the dish configuration items of the list of dish configuration choices for building a selected dish further includes at least one of possible beverages, possible complementary dishes and possible options/extras and wherein the custom presentation of at least one of the possible beverages, possible complementary dishes and possible options/extras includes a selection of an image associated to the corresponding one of the possible beverages, possible complementary dishes and possible options/extras, a selection of a description of the corresponding one of the possible beverages, possible complementary dishes and possible options/extras and a rank/sequence for the presentation of the corresponding one of the possible beverages, possible complementary dishes and possible options/extras.

6. (canceled)

7. The computer implemented method of claim 1, further comprising generating specific menu or dish configuration item recommendations for an item of at least one of the menu presentation and the dish configuration presentation using a recommender system including at least one machine learning recommendation model trained using a labelled dataset.

8. The computer implemented method of claim 7, wherein the labelled dataset comprises data labelled using at least one of dish/food attribute data, historical user data, historical purchase data and contextual data regarding purchases.

9. The computer implemented method of claim 7, wherein the step of generating specific menu or dish configuration item recommendations for an aspect of at least one of the menu presentation and the dish configuration presentation using a recommender system comprises selecting at least one recommended system from a plurality of available recommender systems.

10. The computer implemented method of claim 7, further comprising receiving feedback data, processing the feedback data to generate an updated dataset and using the updated dataset to train a corresponding one of the at least one machine learning recommendation model.

11. The computer implemented method of claim 1, wherein at least one of the steps of dynamically generating a menu presentation and dynamically generating a dish configuration presentation comprises generating a recommendation vector including a plurality of menu or dish configuration item recommendations and filtering the entries of the recommendation vector based on business rules associated to a corresponding restaurant.

12. (canceled)

13. A system for automatic and dynamic menu and dish presentation in a dish ordering environment, the system comprising:
a front end module including a user interface to be presented on a display media of a user computing device;
a back end module in data communication with a plurality of data sources and receiving therefrom menu data inputs, the back end module comprising:
a dynamic menu presentation module configured to dynamically generate a menu presentation to be presented on the user interface of the front end module, the menu presentation including at least one of a list of categories, a defined rank/sequence for the presentation of the categories, a list of dish for each category and a custom presentation of each dish;
a dynamic dish configuration scheme module configured to receive user input data generated based on user inputs received from the computing device regarding user selections of menu items from a menu presented on the user interface in accordance with the menu presentation, the dynamic dish configuration scheme module being further configured to dynamically generate a dish configuration presentation to be presented on the user interface of the front end module, based on the user inputs and including at least one of a list of dish configuration choices for building a selected dish and a defined rank/sequence for the presentation of the configuration choices, with dish configuration items provided for each one of the dish configuration choices having a custom presentation.

14. The system of claim 13, wherein the custom presentation of each dish includes at least one of a selection of an image associated with the dish, a selection of a description of the dish and a rank/sequence for the presentation of the dish in the associated category.

15. The system of claim 13, wherein the dish configuration items of the list of dish configuration choices for building a selected dish includes possible side dishes and wherein the custom presentation of side dishes includes a selection of an image associated to the corresponding one of the side dishes, a selection of a description of the corresponding one of the side dishes and a rank/sequence for the presentation of the corresponding one of the side dishes.

16. (canceled)

17. The system of claim 15, wherein the dish configuration items of the list of dish configuration choices for building a selected dish further includes at least one of possible beverages, possible complementary dishes and possible options/extras and wherein the custom presentation of at least one of the possible beverages, possible complementary dishes and possible options/extras includes a selection of an image associated to the corresponding one of the possible beverages, possible complementary dishes and possible options/extras, a selection of a description of the corresponding one of the possible beverages, possible complementary dishes and possible options/extras and a rank/sequence for the presentation of the corresponding one of the possible beverages, possible complementary dishes and possible options/extras.

18. (canceled)

19. The system of claim 13, further comprising a machine learning recommendation module in data communication with the back end module, the machine learning recommendation module being configured to generate a vector including a plurality of menu or dish configuration item recommendations used by at least one of the dynamic menu presentation module and the dynamic dish configuration scheme module to respectively generate the menu presentation and the dish configuration presentation.

20. The system of claim 19, wherein the machine learning recommendation module includes a plurality of recommender systems, each configured to provide specific menu or dish configuration item recommendations for a corresponding one of an item of the menu presentation or an item of the dish configuration presentation and wherein each one of the recommender systems includes a recommender algorithm and at least one machine learning recommendation model trained using a labelled dataset.

21. (canceled)

22. The system of claim 20, wherein the labelled dataset comprises data labelled using at least one of dish/food attribute data, historical user data, historical purchase data and contextual data regarding purchases.

23. The system of any one of claim 19, further comprising a business rule module filtering the entries of the recommendation vector based on business rules associated to a corresponding restaurant.

24. The system of any one of claim 19, wherein the machine learning recommendation module is in data communication with an AI data service connected to an AI database and a feature store connected to an online serving datastore, the system further comprising a feedback module receiving raw feedback data from the back end module and storing the raw feedback data in a feedback datastore.

25. The system of claim 24, wherein the feedback module comprises a batch processor repeatedly processing raw feedback data from the feedback datastore in batch and storing the processed data in an intermediate database and a service processing module processing the semi-processed processed data from the intermediate database and updating the AI database and the AI data service to reflect changes to the intermediate database.

26. (canceled)

27. The system of claim 25, wherein the feedback module further comprises a dataset creation module configured to process the semi-processed data from the intermediate database and to generate a training dataset adapted to a corresponding machine learning recommendation model.

28. The system of claim 27, wherein the feedback module further comprises a feature update module configured to generate features for the corresponding machine learning recommendation model and to update the feature store and online serving datastore accordingly.

29. The system of claim 27, wherein the feedback module further comprises a model training module configured to perform training of the corresponding machine learning recommendation model using the generated dataset.

30. (canceled)
